(19) United States
(12) Patent Application Publication
(10) Pub. No.: US 2007/0097530 A1
(43) Pub. Date: May 3, 2007

(54) Optical devices

(75) Inventors: Li-Te Kuo, Hsinchu County (TW); Chau-Shin Jang, Hsinchu County (TW); Mei-Lin Lai, Taichung County (TW); Shyh-Jier Wang, Hsinchu County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/266,832

(22) Filed: Nov. 3, 2005

(51) Int. Cl. G02B 7/02

(52) U.S. Cl. 359/823

(57) ABSTRACT

An optical device. At least one guide bar is connected to a base. A coil is disposed in the base. A central axis of the coil in an optical axis direction of the optical device is parallel to a central axis of the guide bar in the optical axis direction. A lens housing is slidably fitted on the guide bar. A central axis of the lens housing in the optical axis direction is parallel to that of the guide bar. The lens housing slides along the central axis of the guide bar. A magnetic member is connected to the lens housing opposite the coil, providing a first magnetic field. When the coil is energized to generate a second magnetic field, the lens housing slides on the guide bar by attraction or repulsion of the first and second magnetic fields.

### BACKGROUND

The invention relates to optical devices, and in particular to optical devices having lenses capable of rapid focusing movement and precise positioning.

In some conventional cameras, the focusing movement of lenses is driven by stepping motors. The lenses driven by the stepping motors are easily controlled and do not require additional electricity to maintain the position thereof. The stepping motors, however, provide poor positioning precision and slow driving speed. In addition, stepping motors are quite large in size. This reduces their applicability and increases the size of cameras in which they are implemented.

To overcome the aforementioned problems, the focusing movement of lenses in other conventional cameras is driven by voice coil motors, as disclosed in U.S. Pat. No. 5,939,804. The voice coil motors provide faster driving speed, better positioning precision, and a reduced size.

Generally, the Biot-Savart law is applied in operation of the voice coil motors. The Biot-Savart law indicates that a conducting wire with a length L is subject to a force F when energized with an electric current I and located in a magnetic field with a magnetic flux B. The direction of the magnetic field is perpendicular to that of the electric current I. The magnitude of the force F equals IL×B, and the direction thereof is perpendicular to those of the electric current and magnetic field. A conventional voice coil motor or optical equipment applying the Biot-Savart law is disclosed in U.S. Pat. No. 5,939,804.

Moreover, in U.S. Pat. No. 4,678,951 and U.S. Pat. No. 5,939,804, voice coil motors or optical devices apply the Biot-Savart law and comprise a linear guiding structure. Voice coil motors or optical devices, as disclosed in U.S. Pat. No. 6,560,047, apply the Biot-Savart law and comprise a pre-compressed resilient mechanism (i.e. a suspension mechanism), Additionally, in a lens driving device disclosed in U.S. Pat. No. 6,856,469, a magnet (movable member) and a coil (fixed member) of a voice coil motor are disposed in a circumferential direction. The coil surrounds the magnet and the magnet moves upward and downward inside the coil.

Accordingly, the conventional cameras or optical devices applying the voice coil motors have the following drawbacks. The farther the lenses move, the higher the voltage required by the voice coil motors. When the lenses move to a target focus position, additional electricity (or electric current) is required by the voice coil motors to maintain the lenses at the target focus position. Thus, the conventional cameras or optical devices applying the voice coil motors consume a great deal of electricity, adversely affecting portability and applicability thereof.

Hence, there is a need for a linearly guided optical device having a lens capable of rapid focusing movement and precise positioning with reduced electrical consumption.

### SUMMARY

Accordingly, an embodiment of the invention provides an optical device comprising a base, at least one guide bar, a coil, a lens housing, and a magnetic member. The guide bar is connected to the base. The coil is disposed in the base. A central axis of the coil in the optical axis direction of the optical device is parallel to a central axis of the guide bar in the optical axis direction. The lens housing is slidably fitted on the guide bar. A central axis of the lens housing in the optical axis direction is also parallel to that of the guide bar in the optical axis direction. The lens housing slides along the central axis of the guide bar. The magnetic member is connected to the lens housing opposite the coil, providing a first magnetic field. When the coil is energized to generate a second magnetic field, the lens housing slides on the guide bar by attraction or repulsion of the first and second magnetic fields.

In preferred embodiments, the optical device further comprises a magnetic-permeable member disposed in the coil to enhance attraction or repulsion between the magnetic member and the coil. The magnetic-permeable member is preferably a yoke.

The optical device may also comprise a magnetic field sensing member disposed on the guide bar opposite the magnetic member to detect movement of the magnetic member. In preferred embodiments, the magnetic field sensing member comprises a Hall sensor.

In addition, the optical device preferably comprises a positioning member disposed on the guide bar opposite the magnetic member. The positioning member attracts the magnetic member to bring the lens housing into abutment with the guide bar. The positioning member may comprise metal or a magnet, while the magnetic member comprises a magnet.

In preferred embodiments, the optical device further comprises a lens and an image-sensing member. The lens is disposed in the lens housing, and the image-sensing member is disposed in the base opposite the lens.

Another embodiment of the invention provides an optical device comprising a base, at least one guide bar, at least one coil, a lens housing, and at least one magnetic member. The guide bar is connected to the base. The coil is disposed in the base and preferably fitted on the guide bar. The lens housing is slidably fitted on the guide bar. A central axis of the lens housing in the optical axis direction of the optical device is parallel to a central axis of the guide bar in the optical axis direction. The lens housing slides along the central axis of the guide bar. A central axis of the coil in the optical axis direction is aligned with that of the guide bar in the optical axis direction. The magnetic member is connected to the lens housing and preferably slidably fitted on the guide bar. The magnetic member is disposed opposite the coil, providing a first magnetic field. When the coil is energized to generate a second magnetic field, the lens housing slides on the guide bar by attraction or repulsion of the first and second magnetic fields.

Yet another embodiment of the invention provides an optical device comprising a base, at least one guide bar, a lens housing, a coil, and a magnetic member. The guide bar is connected to the base. The lens housing is slidably fitted on the guide bar. A central axis of the lens housing in the optical axis direction of the optical device is parallel to a central axis of the guide bar in the optical axis direction. The lens housing slides along the central axis of the guide bar. The coil is disposed on the lens housing. A central axis of the coil in the optical axis direction is also parallel to that of the guide bar in the optical axis direction. The magnetic member is disposed in the base opposite the coil, providing a first magnetic field. When the coil is energized to generate a second magnetic field, the lens housing slides on the guide bar by attraction or repulsion of the first and second magnetic fields.

Still another embodiment of the invention provides an optical device comprising a base, at least one guide bar, a lens housing, at least one coil, and at least one magnetic member. The guide bar is connected to the base. The lens housing is slidably fitted on the guide bar. A central axis of the lens housing in the optical axis direction of the optical device is parallel to a central axis of the guide bar in the optical axis direction. The lens housing slides along the central axis of the guide bar. The coil is disposed on the lens housing and preferably fitted on the guide bar. A central axis of the coil in the optical axis direction is aligned with that of the guide bar. The magnetic member is disposed in the base and preferably fitted on the guide bar. The magnetic member is disposed opposite the coil, providing a first magnetic field. When the coil is energized to generate a second magnetic field, the lens housing slides on the guide bar by attraction or repulsion of the first and second magnetic fields.

Still another embodiment of the invention provides an optical device comprising a base, a lens housing, a coil, and a magnetic member. The base comprises an inner wall. The lens housing is slidably disposed in the base and abuts the inner wall thereof. The coil is disposed in the base. A central axis of the coil in the optical axis direction of the optical device is aligned with a central axis of the lens housing in the optical axis direction. The magnetic member is connected to the lens housing opposite the coil, providing a first magnetic field. When the coil is energized to generate a second magnetic field, the lens housing slides in the base by attraction or repulsion of the first and second magnetic fields.

Still another embodiment of the invention provides an optical device comprising a base, a lens housing, a coil, and a magnetic member. The base comprises an inner wall. The lens housing is slidably disposed in the base and abuts the inner wall thereof. The coil is disposed on the lens housing. A central axis of the coil in the optical axis direction of the optical device is aligned with a central axis of the lens housing in the optical axis direction. The magnetic member is disposed in the base opposite the coil, providing a first magnetic field. When the coil is energized to generate a second magnetic field, the lens housing slides in the base by attraction or repulsion of the first and second magnetic fields.

### DESCRIPTION OF THE DRAWINGS

The invention can be more fully understood by reading the subsequent detailed description and examples with references made to the accompanying drawings, wherein:

FIG. 1 is a schematic partial cross section of the optical device of a first embodiment of the invention;

FIG. 2 is a schematic partial cross section of the optical device of a second embodiment of the invention;

FIG. 3 is a schematic partial cross section of the optical device of a third embodiment of the invention;

FIG. 4 is a schematic partial cross section of the optical device of a fourth embodiment of the invention;

FIG. 5 is a schematic partial cross section of the optical device of a fifth embodiment of the invention;

FIG. 6 is a schematic partial cross section of the optical device of a sixth embodiment of the invention;

FIG. 7 is a schematic partial cross section of the optical device of a seventh embodiment of the invention;

FIG. 8 is a schematic partial cross section of the optical device of an eighth embodiment of the invention;

FIG. 9 is a schematic partial cross section of the optical device of a ninth embodiment of the invention; and

FIG. 10 is a schematic partial cross section of the optical device of a tenth embodiment of the invention.

### DETAILED DESCRIPTION

### First Embodiment

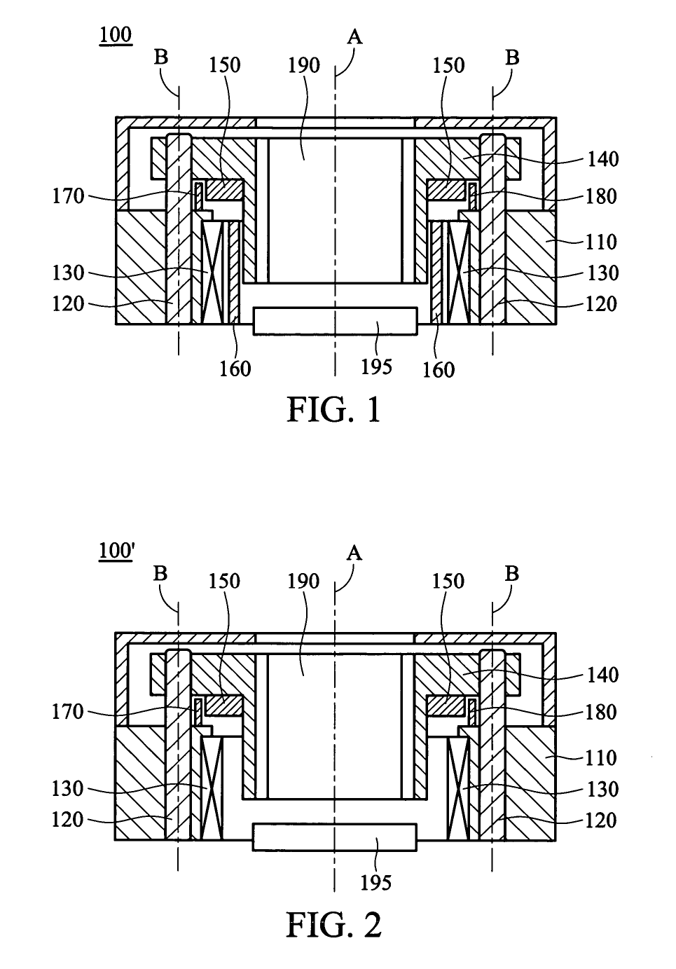

Referring to FIG. 1, the optical device 100 comprises a base 110, two guide bars 120, a coil 130, a lens housing 140, a magnetic member 150, a magnetic-permeable member 160, a magnetic field sensing member 170, a positioning member 180, a lens 190, and an image-sensing member 195.

As shown in FIG. 1, the guide bars 120 are connected to the base 110, and the coil 130 is disposed in the base 110. Specifically, a central axis A of the coil 130 in the optical axis direction of the optical device is parallel to a central axis B of each guide bar 120 in the optical axis direction. Moreover, the magnetic-permeable member 160 is disposed in the coil 130. In this embodiment, the magnetic-permeable member 160 is a yoke.

The lens housing 140 is slidably fitted on the guide bars 120. A central axis A of the lens housing 140 in the optical axis direction is parallel to the central axis B of each guide bar 120 in the optical axis direction. The lens housing 140 can thus slide along the central axes of the guide bars 120. Moreover, the lens 190 is disposed in the lens housing 140.

The magnetic member 150 is connected to the lens housing 140 opposite the coil 130. Specifically, a central axis A of the magnetic member 150 in the optical axis direction is aligned with that of the coil 130, and the magnetic member 150 is disposed above the coil 130. The magnetic member 150 provides a first magnetic field. The direction of the first magnetic field is substantially parallel to the central axis of each guide bar 120 or the lens housing 140. The magnetic member 150 may be a magnet.

The magnetic field sensing member 170 is disposed on the base 110 opposite the magnetic member 150. The magnetic field sensing member 170 detects movement of the magnetic member 150. For example, the magnetic field sensing member 170 may be a Hall sensor connected to a controller (not shown) for measuring magnetic field strength and polarity. The movement and position of the magnetic member 150 can be obtained by detecting changes in magnetic flux density and/or polarity of the magnetic field produced by magnetic member 150 with the Hall sensor.

The positioning member 180 is disposed on the base 110 opposite the magnetic member 150. The positioning member 180 may be metal (such as an iron plate) or a magnet.

The image-sensing member 195 is disposed in the base 110 opposite the lens 190. The image-sensing member 195 may be a CCD or a CMOS.

The following description is directed to operation of the optical device 100 or focusing movement of the lens 190.

As shown in FIG. 1, the magnetic member 150 connected to the lens housing 140 provides the first magnetic field having a direction substantially parallel to the central axis of each guide bar 120 or the lens housing 140. When the coil 130 is energized, a second magnetic field having a direction parallel to the central axis of each guide bars 120 or the lens housing 140, is generated in the center of the coil 130. When the directions of the first and second magnetic fields are the same, the magnetic member 150 and coil 130 attract each other. On the contrary, when the directions of the first and second magnetic fields are opposite, the magnetic member 150 and coil 130 repulse each other. Accordingly, the lens housing 140 can slide on the guide bars 120 by attraction and repulsion of the first and second magnetic fields, thereby adjusting the focus position of the lens 190 (i.e. the distance between the lens 190 and the image-sensing member 195). The direction of the second magnetic field is determined by the direction of the electric current applied in the coil 130, and the strength of the second magnetic field is determined according to the magnitude of the electric current applied in the coil 130. Moreover, the magnetic-permeable member 160 can effectively guide magnetic lines provided by the first magnetic field into the coil 130, thereby enhancing attraction or repulsion between the magnetic member 150 and the coil 130.

The magnetic field sensing member 170 (Hall sensor) detects the changes in magnetic flux density and/or polarity of the magnetic field produced by magnetic member 150 and transforms the detected changes in magnetic flux density into a signal. The signal is transmitted to the controller connected to the magnetic field sensing member 170 (Hall sensor) and the position and speed of the magnetic member 150 are thus obtained. The controller can adjust the magnitude of the electric current applied in the coil 130 according to the signal, changing the moving speed of the lens housing 140 or lens 190. The focusing speed of the lens 190 is thus adjusted.

Moreover, the guide bars 120 can prevent displacement of the lens housing 140 due to rotation torque resulting from deviation of magnetic force, thereby ensuring straight movement of the lens housing 140. Nevertheless, when the lens housing 140 is fitted on the guide bars 120, a minor tolerance of assembly exists there between. By attraction between the magnetic member 150 and the positioning member 180, the lens housing 140 can tightly abut one of the guide bars 120 and slide thereon. Accordingly, inclination of the lens housing 140 can thus be prevented. Namely, the lens housing 140 can slide on the guide bars 120 without deviation by attraction between the magnetic member 150 and the positioning member 180.

### Second Embodiment

Elements corresponding to those in the first embodiment share the same reference numerals.

Referring to FIG. 2, the difference between the second and the first embodiment is that the optical device 100′ of this embodiment does not comprise a magnetic-permeable member. Nevertheless, the lens housing 140 can still slide on the guide bars 120 by attraction or repulsion of the first and second magnetic fields, thereby adjusting the focus position of the lens 190 (i.e. the distance between the lens 190 and the image-sensing member 195).

The structure, disposition, and function of other elements of the optical device 100′ are the same as those of the optical device 100, and explanation thereof is omitted.

### Third Embodiment

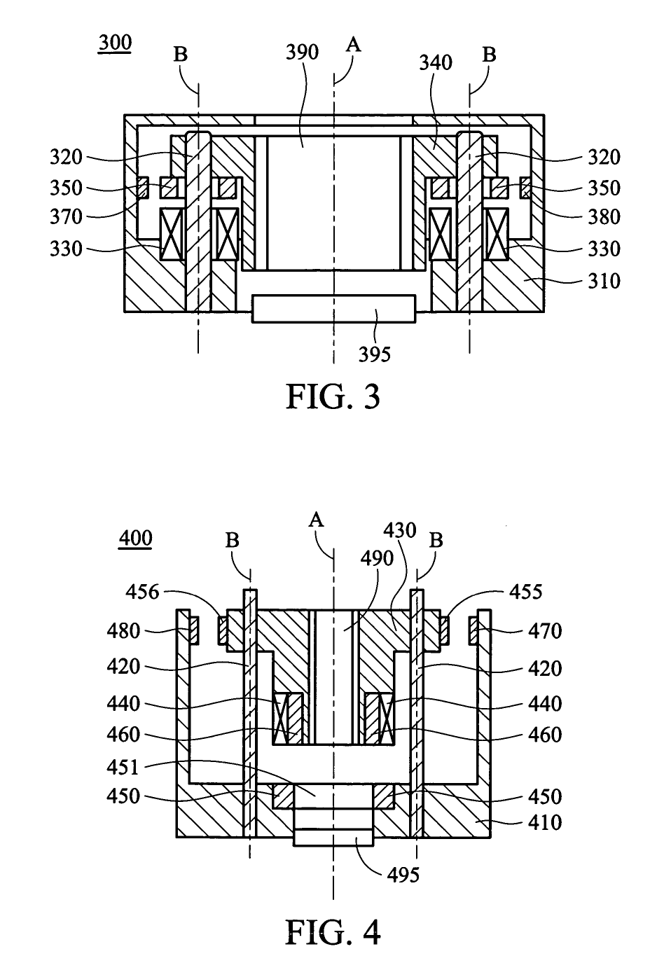

Referring to FIG. 3, the optical device 300 comprises a base 310, two guide bars 320, two coils 330, a lens housing 340, two magnetic members 350, a magnetic field sensing members 370, a positioning member 380, a lens 390, and an image-sensing member 395.

As shown in FIG. 3, the guide bars 320 are connected to the base 310. The lens housing 340 is slidably fitted on the guide bars 320. A central axis A of the lens housing 340 in the optical axis direction of the optical device is parallel to a central axis B, of each guide bar 320. The lens housing 340 can thus slide along the central axes of the guide bars 320. Moreover, the lens 390 is disposed in the lens housing 340.

The coils 330 are disposed in the base 310 and are respectively fitted on the guide bars 320. Specifically, a central axis B of each coil 330 in the optical axis direction of the optical device is aligned with the central axis B of each guide bar 320 in the optical axis direction.

The magnetic members 350 are connected to the lens housing 340 and slidably fitted on the guide bars 320, respectively. Specifically, the magnetic members 350 are respectively disposed opposite the coils 330. A central axis B of each magnetic member 350 in the optical axis direction is aligned with that of each corresponding coil 330, and the magnetic members 350 are disposed above the coils 330. Each magnetic member 350 provides a first magnetic field. The direction of the first magnetic field is substantially parallel to the central axis of each guide bar 320 or the lens housing 340. The magnetic members 350 may be magnets.

The magnetic field sensing member 370 is disposed on the base 310 opposite one of the magnetic members 350. The magnetic field sensing member 370 detects movement of the magnetic members 350. The magnetic field sensing member 370 may be a Hall sensor connected to a controller (not shown) for measuring magnetic field strength and polarity. The movement and position of the magnetic members 350 can be obtained by detecting changes in magnetic flux density and/or polarity of the magnetic fields produced by magnetic members 350 with the Hall sensor.

The positioning member 380 is disposed the base 310 opposite one of the magnetic members 350. The positioning member 380 may be metal (such as an iron plate) or a magnet.

The image-sensing member 395 is disposed in the base 310 opposite the lens 390. The image-sensing member 395 may be a CCD or a CMOS.

The following description is directed to operation of the optical device 300 or focusing movement of the lens 390.

As shown in FIG. 3, each magnetic member 350 connected to the lens housing 340 provides the first magnetic field having a direction substantially parallel to the central axis of each guide bar 320 or the lens housing 340. When the coils 330 are simultaneously energized, a second magnetic field having a direction parallel to the central axis of each guide bar 320 or the lens housing 340, is generated in the center of each coil 330. When the directions of the first and second magnetic fields are the same, the magnetic members 350 and coils 330 attract each other. On the contrary, when the directions of the first and second magnetic fields are opposite, the magnetic members 350 and coils 330 repulse each other. Accordingly, the lens housing 340 can slide on the guide bars 320 by attraction and repulsion of the first and second magnetic fields, thereby adjusting focus position of the lens 390 (i.e. the distance between the lens 390 and the image-sensing member 395). The direction of the second magnetic field is determined by the direction of the electric current applied in each coil 330, and the strength of the second magnetic field is determined according to the magnitude of the electric current applied in each coil 330. In this embodiment, the directions of the electric currents applied in the coils 330 must be the same.

Moreover, the guide bars 320 may comprise a magnetic-permeable material, such that magnetic lines provided by the first magnetic field can be effectively guided into the coils 330 or magnetic lines provided by the second magnetic field effectively guided into the magnetic members 350. Accordingly, attraction or repulsion between the magnetic members 350 and the coils 330 is enhanced.

The magnetic field sensing member 370 (Hall sensor) detects the changes in magnetic flux density and/or polarity of the magnetic fields produced by magnetic members 350 and transforms the detected changes into a signal. The signal is transmitted to the controller connected to the magnetic field sensing member 370 (Hall sensor) and the position and speed of the magnetic members 350 are thus obtained. The controller can adjust the magnitude of the electric currents applied in the coils 330 according to the signal, changing the moving speed of the lens housing 340 or lens 390. The focusing speed of the lens 390 is thus adjusted.

The guide bars 320 can prevent displacement of the lens housing 340 due to rotation torque resulting from deviation of magnetic force, thereby ensuring straight movement of the lens housing 340. When the lens housing 340 is fitted on the guide bars 320, a minor tolerance of assembly exists there between. By attraction between one of the magnetic members 350 and the positioning member 380, the lens housing 340 can tightly abut one of the guide bars 320 and slide thereon. Accordingly, inclination of the lens housing 340 can thus be prevented. Namely, the lens housing 340 can slide on the guide bars 320 without deviation by attraction between one of the magnetic members 350 and the positioning member 380.

### Fourth Embodiment

Referring to FIG. 4, the optical device 400 comprises a base 410, two guide bars 420, a lens housing 430, a coil 440, a first magnetic member 450, a second magnetic member 455, a third magnetic member 456, a magnetic-permeable member 460, a magnetic field sensing member 470, a positioning member 480, a lens 490, and an image-sensing member 495.

As shown in FIG. 4, the guide bars 420 are connected to the base 410, and the lens housing 430 is slidably fitted on the guide bars 420. A central axis A of the lens housing 430 in the optical axis direction of the optical device is parallel to a central axis B of each guide bar 420 in the optical axis direction. The lens housing 430 can thus slide along the central axes of the guide bars 420. Moreover, the lens 490 is disposed in the lens housing 430.

The coil 440 is disposed on the lens housing 430. A central axis A of the coil 440 in the optical axis direction is parallel to the central axis B of each guide bar 420.

The first magnetic member 450 is disposed in the base 410 opposite the coil 440 and comprises a through hole 451. Specifically, a central axis A of the first magnetic member 450 in the optical axis direction is aligned with that of the coil 440, and the first magnetic member 450 is disposed under the coil 440. The first magnetic member 450 provides a first magnetic field. The direction of the first magnetic field is substantially parallel to the central axis of each guide bar 420 or the lens housing 430. The first magnetic member 450 may be a magnet.

The second magnetic member 455 and third magnetic member 456 are connected to-the lens housing 430.

The magnetic-permeable member 460 is disposed on the lens housing 430 and in the coil 440. The magnetic-permeable member 460 may be a yoke.

The magnetic field sensing member 470 and positioning member 480 are disposed on the base 410 and opposite the second magnetic member 455 and third magnetic member 456, respectively.

The image-sensing member 495 is disposed in the base 410 and under the first magnetic member 450. Specifically, the image-sensing member 495 is disposed opposite the lens 490 below the through hole 451 of the first magnetic member 450. The image-sensing member 495 may be a CCD or a CMOS.

The following description is directed to operation of the optical device 400 or focusing movement of the lens 490.

As shown in FIG. 4, the first magnetic member 450 disposed in the base 410 provides the first magnetic field having a direction substantially parallel to the central axis of each guide bar 420 or the lens housing 430. When the coil 440 is energized, a second magnetic field having a direction parallel to the central axis of each guide bar 420 or the lens housing 430, is generated in the center of the coil 440. When the directions of the first and second magnetic fields are the same, the first magnetic member 450 and coil 440 attract each other. On the contrary, when the directions of the first and second magnetic fields are opposite, the first magnetic member 450 and coil 440 repulse each other. Accordingly, the lens housing 430 can slide on the guide bars 420 by attraction and repulsion of the first and second magnetic fields, thereby adjusting focus position of the lens 490 (i.e. the distance between the lens 490 and the image-sensing member 495). The direction of the second magnetic field is determined by the direction of the electric current applied in the coil 440, and the strength of the second magnetic field is determined according to the magnitude of the electric current applied in the coil 440. The magnetic-permeable member 460 can effectively guide magnetic lines provided by the first magnetic field into the coil 440, thereby enhancing attraction or repulsion between the first magnetic member 450 and the coil 440.

Similarly, the movement of the lens housing 430 can be detected by interaction between the second magnetic member 455 and magnetic field sensing member 470, and the positioning member 480 attracts the third magnetic member 456 to bring the lens housing 430 into abutment with the guide bars 420.

### Fifth Embodiment

Elements corresponding to those in the fourth embodiment share the same reference numerals.

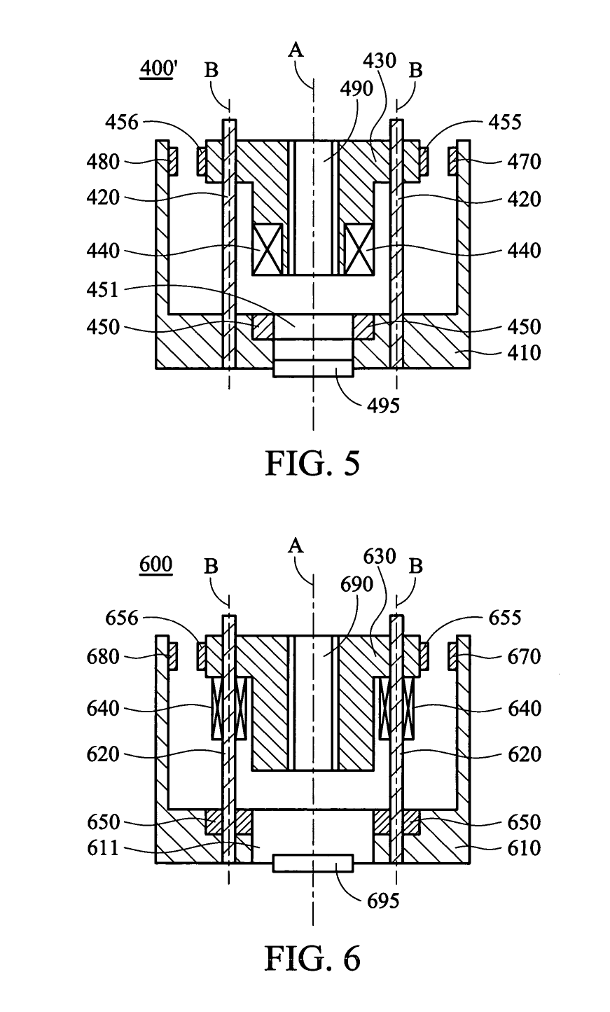

Referring to FIG. 5, the difference between the fifth and the fourth embodiment is that the optical device 400′ of this embodiment does not comprise a magnetic-permeable member. Nevertheless, the lens housing 430 can still slide on the guide bars 420 by attraction or repulsion of the first and second magnetic fields, thereby adjusting the focus position of the lens 490 (i.e. the distance between the lens 490 and the image-sensing member 495).

The structure, disposition, and function of other elements of the optical device 400′ are the same as those of the optical device 400, and explanation thereof is omitted.

### Sixth Embodiment

Referring to FIG. 6, the optical device 600 comprises a base 610, two guide bars 620, a lens housing 630, two coils 640, two first magnetic members 650, a second magnetic member 655, a third magnetic member 656, a magnetic field sensing member 670, a positioning member 680, a lens 690, and an image-sensing member 695.

As shown in FIG. 6, the guide bars 620 are connected to the base 610, and the lens housing 630 is slidably fitted on the guide bars 620. A central axis A of the lens housing 630 in the optical axis direction of the optical device is parallel to a central axis B of each guide bar 620 in the optical axis direction. The lens housing 630 can thus slide along the central axes of the guide bars 620. Moreover, the lens 690 is disposed in the lens housing 630.

The coils 640 are disposed on the lens housing 630 and are respectively fitted on the guide bars 620. Specifically, a central axis B of each coil 640 in the optical axis direction is aligned with the central axis B of each guide bar 620.

The first magnetic members 650 are disposed in the base 610 and are slidably fitted on the guide bars 620, respectively. Specifically, a central axis B of each first magnetic member 650 in the optical axis direction is aligned with that of each corresponding coil 640, and the first magnetic members 650 are disposed under the coils 640. Each first magnetic member 650 provides a first magnetic field. The direction of the first magnetic field is substantially parallel to the central axis of each guide bar 620. The first magnetic members 650 may be magnets.

The second magnetic member 655 and third magnetic member 656 are connected to the lens housing 630.

The magnetic field sensing member 670 and positioning member 680 are disposed on the base 610 and opposite the second magnetic member 655 and third magnetic member 656, respectively.

The image-sensing member 695 is disposed in the base 610 and under the first magnetic members 650. Specifically, the image-sensing member 695 is disposed opposite the lens 690 below a through hole 611 of the base 610. The image-sensing member 695 may be a CCD or a CMOS.

Moreover, the guide bars 620 may optionally comprise a magnetic-permeable material.

The following description is directed to operation of the optical device 600 or focusing movement of the lens 690.

As shown in FIG. 6, each first magnetic member 650 disposed in the base 610 provides the first magnetic field having a direction substantially parallel to the central axis of each guide bar 620. When the coils 640 are simultaneously energized, a second magnetic field having a direction parallel to the central axis of each guide bar 620 is generated in the center of each coil 640. When the directions of the first and second magnetic fields are the same, the first magnetic members 650 and coils 640 attract each other. On the contrary, when the directions of the first and second magnetic fields are opposite, the first magnetic members 650 and coils 640 repulse each other. Accordingly, the lens housing 630 can slide on the guide bars 620 by attraction and repulsion of, the first and second magnetic fields, thereby adjusting focus position of the lens 690 (i.e. the distance between the lens 690 and the image-sensing member 695). The direction of the second magnetic field is determined by the direction of the electric current applied in each coil 640, and the strength of the second magnetic field is determined according to the magnitude of the electric current applied in each coil 640. Moreover, when the guide bars 620 comprise the magnetic-permeable material, magnetic lines provided by the first magnetic field can be more effectively guided into the coils 640. Attraction or repulsion between the first magnetic members 650 and the coils 640 is thus enhanced.

Similarly, the movement of the lens housing 630 can be detected by interaction between the second magnetic member 655 and magnetic field sensing member 670, and the positioning member 680 attracts the third magnetic member 656 to bring the lens housing 630 into abutment with the guide bars 620.

### Seventh Embodiment

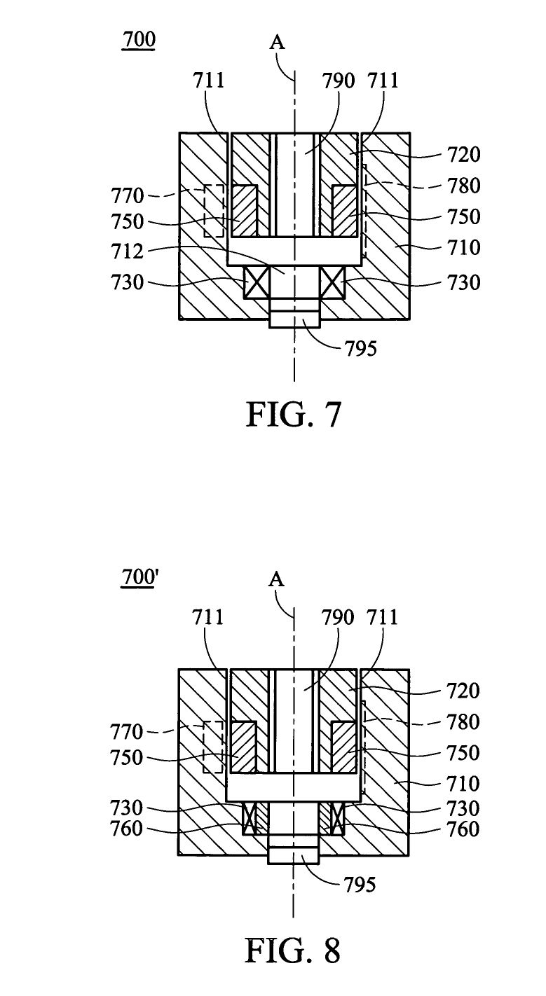

Referring to FIG. 7, the optical device 700 comprises a base 710, a lens housing 720, a coil 730, a magnetic member 750, a magnetic field sensing member 770, a positioning member 780, a lens 790, and an image-sensing member 795.

As shown in FIG. 7, the base 710 comprises an inner wall 711. The lens housing 720 is slidably disposed in the base 710 and abuts the inner wall 711 thereof. Namely, the lens housing 720 slidably abuts the inner wall 711 of the base 710. Moreover, the lens 790 is disposed in the lens housing 720.

The coil 730 is disposed in the base 710. A central axis A of the coil 730 in the optical axis direction of the optical device is aligned with a central axis A of the lens housing 720 in the optical axis direction.

The magnetic member 750 is connected to the lens housing 720 opposite the coil 730. Specifically, a central axis A of the magnetic member 750 in the optical axis direction is aligned with that of the coil 730, and the magnetic member 750 is disposed above the coil 730. The magnetic member 750 provides a first magnetic field. The direction of the first magnetic field is substantially parallel to the central axis of the lens housing 720. The magnetic member 750 may be a magnet.

The magnetic field sensing member 770 is disposed in the base 710 opposite the magnetic member 750. The magnetic field sensing member 770 detects movement of the magnetic member 750. The magnetic field sensing member 770 may be a Hall sensor connected to a controller (not shown) for measuring magnetic field strength and polarity. The movement and position of the magnetic member 750 can be obtained by detecting changes in magnetic flux density and/or polarity of the magnetic field produced by magnetic member 750 with the Hall sensor.

The positioning member 780 is disposed in the base 710 opposite the magnetic member 750. The positioning member 780 may be metal (such as an iron plate) or a magnet.

The image-sensing member 795 is disposed in the base 710 opposite the lens 790. Specifically, the image-sensing member 795 is disposed opposite the lens 790 below a through hole 711 of the base 710. The image-sensing member 795 may be a CCD or a CMOS.

The following description is directed to operation of the optical device 700 or focusing movement of the lens 790.

As shown in FIG. 7, the magnetic member 750 connected to the lens housing 720 provides the first magnetic field having a direction substantially parallel to the central axis of A the lens housing 720. When the coil 730 is energized, a second magnetic field having a direction parallel to the central axis A of the lens housing 720, is generated in the center of the coil 730. When the directions of the first and second magnetic fields are the same, the magnetic member 750 and coil 730 attract each other. On the contrary, when the directions of the first and second magnetic fields are opposite, the magnetic member 750 and coil 730 repulse each other. Accordingly, the lens housing 720 can slide in the base 710 by attraction and repulsion of the first and second magnetic fields, thereby adjusting focus position of the lens 790 (i.e. the distance between the lens 790 and the image-sensing member 795). The direction of the second magnetic field is determined by the direction of the electric current applied in the coil 730, and the strength of the second magnetic field is determined according to the magnitude of the electric current applied in the coil 730.

The magnetic field sensing member 770 (Hall sensor) detects the changes in magnetic flux density and polarity of the magnetic field produced by magnetic member 750 and transforms the detected changes into a signal. The signal is transmitted to the controller connected to the magnetic field sensing member 770 (Hall sensor) and the position and speed of the magnetic member 750 are thus obtained. The controller can adjust the magnitude of the electric current applied in the coil 730 according to the signal, changing the moving speed of the lens housing 720 or lens 790. The focusing speed of the lens 790 is thus adjusted.

When the lens housing 720 is disposed in the base 710, a minor tolerance of assembly exists between the lens housing 720 and the inner wall 711 of the base 710. By attraction between the magnetic member 750 and the positioning member 780, the lens housing 720 can tightly abut the inner wall 711 of the base 710 and slide thereon. Accordingly, inclination of the lens housing 720 can thus be prevented. Namely, the lens housing 720 can slide in the base 710 without deviation by attraction between the magnetic member 750 and the positioning member 780.

### Eighth Embodiment

Elements corresponding to those in the seventh embodiment share the same reference numerals.

Referring to FIG. 8, the difference between the eighth and the seventh embodiment is that the optical device 700′ of this embodiment further comprises a magnetic-permeable member 760 disposed in the coil 730. The magnetic-permeable member 760 guides magnetic lines provided by the first magnetic field into the coil 730, thereby enhancing attraction or repulsion between the magnetic member 750 and the coil 730. The magnetic-permeable member 760 may be a yoke.

The structure, disposition, and function of other elements of the optical device 700′ are the same as those of the optical device 700, and explanation thereof is omitted.

### Ninth Embodiment

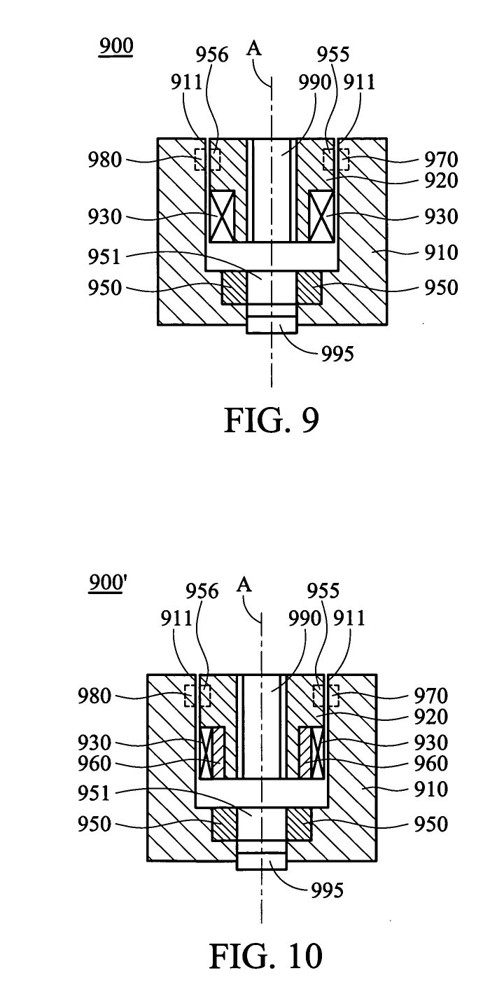

Referring to FIG. 9, the optical device 900 comprises a base 910, a lens housing 920, a coil 930, a first magnetic member 950, a second magnetic member 955, a third magnetic member 956, a magnetic field sensing member 970, a positioning member 980, a lens 990, and an image-sensing member 995.

As shown in FIG. 9, the base 910 comprises an inner wall 911. The lens housing 920 is slidably disposed in the base 910 and abuts the inner wall 911 thereof. Namely, the lens housing 920 slidably abuts the inner wall 911 of the base 910. Moreover, the lens 990 is disposed in the lens housing 920.

The coil 930 is disposed on the lens housing 920. A central axis A of the coil 930 in the optical axis direction of the optical device is aligned with a central axis A of the lens housing 920 in the optical axis direction.

The first magnetic member 950 is disposed in the base 910 opposite the coil 930. Additionally, the first magnetic member 950 comprises a through hole 951. Specifically, a central axis A of the first magnetic member 950 in the optical axis direction is aligned with that of the coil 930, and the first magnetic member 950 is disposed under the coil 930. The first magnetic member 950 provides a first magnetic field. The direction of the first magnetic field is substantially parallel to the central axis of the lens housing 920. The first magnetic member 950 may be a magnet.

The second magnetic member 955 and third magnetic member 956 are disposed in the lens housing 920.

The magnetic field sensing member 970 and positioning member 980 are disposed in the base 910 and opposite the second magnetic member 955 and third magnetic member 956, respectively.

The image-sensing member 995 is disposed in the base 910 and under the first magnetic member 950. Specifically, the image-sensing member 995 is disposed opposite the lens 990 below the through hole 951 of the first magnetic member 950. The image-sensing member 995 may be a CCD or a CMOS.

The following description is directed to operation of the optical device 900 or focusing movement of the lens 990.

As shown in FIG. 9, the first magnetic member 950 disposed in the base 910 provides the first magnetic field having a direction substantially parallel to the central axis of the lens housing 920. When the coil 930 is energized, a second magnetic field having a direction parallel to the central axis of the lens housing 920, is generated in the center of the coil 930. When the directions of the first and second magnetic fields are the same, the first magnetic member 950 and coil 930 attract each other. On the contrary, when the directions of the first and second magnetic fields are opposite, the first magnetic member 950 and coil 930 repulse each other. Accordingly, the lens housing 920 can slide in the base 910 by attraction and repulsion of the first and second magnetic fields, thereby adjusting focus position of the lens 990 (i.e. the distance between the lens 990 and the image-sensing member 995). The direction of the second magnetic field is determined by the direction of the electric current applied in the coil 930, and the strength of the second magnetic field is determined according to the magnitude of the electric current applied in the coil 930.

Similarly, the movement of the lens housing 920 can be detected by interaction between the second magnetic member 955 and magnetic field sensing member 970, and the positioning member 980 attracts the third magnetic member 956 to bring the lens housing 920 into abutment with the base 910.

### Tenth Embodiment

Elements corresponding to those in the ninth Embodiment share the same reference numerals.

Referring to FIG. 10, the difference between the tenth and the ninth Embodiment is that the optical device 900′ of this Embodiment further comprises a magnetic-permeable member 960 disposed in the coil 930. The magnetic-permeable member 960 guides magnetic lines provided by the first magnetic field into the coil 930, thereby enhancing attraction or repulsion between the first magnetic member 950 and the coil 930. The magnetic-permeable member 960 may be a yoke.

The structure, disposition, and function of other elements of the optical device 900′ are the same as those of the optical device 900, and explanation thereof is omitted.

In conclusion, as the disclosed optical device enables focusing movement of the lens by way of attraction or repulsion of two magnetic fields, the electricity required to maintain the lens in the target focus position is reduced. Thus, the disclosed optical device provides reduced electrical consumption. Moreover, the disclosed optical device enables the lens to achieve rapid focusing movement and precise positioning.

While the invention has been described by way of examples and in terms of preferred embodiments, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical device, comprising:
a base;
at least one guide bar connected to the base;
a coil disposed in the base, wherein a central axis of the coil in an optical axis direction of the optical device is parallel to a central axis of the guide bar in the optical axis direction;
a lens housing slidably fitted on the guide bar, wherein a central axis of the lens housing in the optical axis direction is parallel to that of the guide bar, and the lens housing slides along the central axis of the guide bar; and
a magnetic member connected to the lens housing opposite the coil, providing a first magnetic field, wherein, when the coil is energized to generate a second magnetic field by application of a current in a first current direction, the lens housing slides on the guide bar in a first direction by attraction between the first and second magnetic fields, and when the coil is energized to generate a second magnetic field by application of a current in a second current direction, the lens housing slides on the guide bar in a second direction by repulsion between the first and second magnetic fields.

2. The optical device as claimed in claim 1, further comprising a magnetic-permeable member disposed in the coil to enhance attraction or repulsion between the magnetic member and the coil.

3. The optical device as claimed in claim 1, further comprising a magnetic field sensing member disposed on the base opposite the magnetic member to detect movement of the magnetic member.

4. The optical device as claimed in claim 1, further comprising a positioning member disposed on the base opposite the magnetic member, the positioning member attracting the magnetic member to bring the lens housing into abutment with the guide bar.

5. The optical device as claimed in claim 4, wherein the positioning member comprises metal or a magnet.

6. The optical device as claimed in claim 4, wherein the positioning member comprises a coil capable of being energized to generate a magnetic field to react with the magnetic member.

7. The optical device as claimed in claim 1, further comprising a lens and an image-sensing member, wherein the lens is disposed in the lens housing, and the image-sensing member is disposed in the base opposite the lens.

8. An optical device, comprising:
a base;
at least one guide bar connected to the base;
a lens housing slidably fitted on the guide bar, wherein a central axis of the lens housing in an optical axis direction of the optical device is parallel to a central axis of the guide bar in the optical axis direction, and the lens housing slides along the central axis of the guide bar;
at least one coil disposed in the base, wherein a central axis of the coil in an optical axis direction is aligned with that of the guide bar in the optical axis direction; and
at least one magnetic member connected to the lens housing opposite the coil, providing a first magnetic field, wherein, when the coil is energized to generate a second magnetic field by application of a current in a first current direction, the lens housing slides on the guide bar in a first direction by attraction between the first and second magnetic fields, and when the coil is energized to generate a second magnetic field by application of a current in a second current direction, the lens housing slides on the guide bar in a second direction by repulsion between the first and second magnetic fields.

9. The optical device as claimed in claim 8, further comprising at least one magnetic field sensing member disposed on the base opposite the magnetic member to detect movement of the magnetic member.

10. The optical device as claimed in claim 8, further comprising a positioning member disposed on the base opposite the magnetic member, the positioning member attracting the magnetic member to bring the lens housing into abutment with the guide bar.

11. The optical device as claimed in claim 10, wherein the positioning member comprises metal or a magnet.

12. The optical device as claimed in claim 10, wherein the positioning member comprises a coil capable of being energized to generate a magnetic field to react with the magnetic member.

13. The optical device as claimed in claim 8, wherein the guide bar comprises magnetic-permeable material, enhancing attraction or repulsion between the magnetic member and the coil.

14. The optical device as claimed in claim 8, further comprising a lens and an image-sensing member, wherein the lens is disposed in the lens housing, and the image-sensing member is disposed in the base opposite the lens.

15. The optical device as claimed in claim 8, wherein the magnetic member and the coil are slidably fitted on the guide bar.

16. An optical device, comprising:
a base;
at least one guide bar connected to the base;
a lens housing slidably fitted on the guide bar, wherein a central axis of the lens housing in an optical axis direction of the optical device is parallel to a central axis of the guide bar in the optical axis direction, and the lens housing slides along the central axis of the guide bar;
a coil disposed on the lens housing, wherein a central axis of the coil in the optical axis direction is parallel to that of the guide bar; and
a first magnetic member disposed in the base opposite the coil, providing a first magnetic field, wherein, when the coil is energized to generate a second magnetic field by application of a current in a first current direction, the lens housing slides on the guide bar in a first direction by attraction between the first and second magnetic fields, and when the coil is energized to generate a second magnetic field by application of a current in a second current direction, the lens housing slides on the guide bar in a second direction by repulsion between the first and second magnetic fields.

17. The optical device as claimed in claim 16, further comprising a magnetic-permeable member disposed on the lens housing and in the coil to enhance attraction or repulsion between the first magnetic member and the coil.

18. The optical device as claimed in claim 16, further comprising a second magnetic member and a magnetic field sensing member, wherein the second magnetic member is connected to the lens housing, and the magnetic field sensing member is disposed on the base opposite the second magnetic member to detect movement of the lens housing.

19. The optical device as claimed in claim 16, further comprising a third magnetic member and a positioning member, wherein the third magnetic member is connected to the lens housing, and the positioning member is disposed on the base opposite the third magnetic member, and the positioning member attracts the third magnetic member to bring the lens housing into abutment with the guide bar.

20. The optical device as claimed in claim 16, further comprising a lens and an image-sensing member, wherein the first magnetic member comprises a through hole, the lens is disposed in the lens housing, and the image-sensing member is disposed in the base opposite the lens through the through hole.

21. An optical device, comprising:
a base;
at least one guide bar connected to the base;
a lens housing slidably fitted on the guide bar,
wherein a central axis of the lens housing in an optical axis direction of the optical device is parallel to a central axis of the guide bar in the optical axis direction, and the lens housing slides along the central axis of the guide bar;
at least one coil disposed on the lens housing, wherein a central axis of the coil in the optical axis direction is aligned with that of the guide bar; and
at least one first magnetic member disposed in the base opposite the coil, providing a first magnetic field, wherein, when the coil is energized to generate a second magnetic field by application of a current in a first current direction, the lens housing slides on the guide bar in a first direction by attraction between the first and second magnetic fields, and when the coil is energized to generate a second magnetic field by application of a current in a second current direction, the lens housing slides on the guide bar in a second direction by repulsion between the first and second magnetic fields.

22. The optical device as claimed in claim 21, wherein the guide bar comprises magnetic-permeable material, enhancing attraction or repulsion between the first magnetic member and the coil.

23. The optical device as claimed in claim 21, further comprising a second magnetic member and a magnetic field sensing member, wherein the second magnetic member is connected to the lens housing, and the magnetic field sensing member is disposed on the base opposite the second magnetic member to detect movement of the lens housing.

24. The optical device as claimed in claim 21, further comprising a third magnetic member and a positioning member, wherein the third magnetic member is connected to the lens housing, and the positioning member is disposed on the base opposite the third magnetic member, and the positioning member attracts the third magnetic member to bring the lens housing into abutment with the guide bar.

25. The optical device as claimed in claim 21, further comprising a lens and an image-sensing member, wherein the lens is disposed in the lens housing, and the image-sensing member is disposed in the base opposite the lens.

26. The optical device as claimed in claim 21, wherein the first magnetic member and the at least one coil are fitted on the guide bar.

27. An optical device, comprising:
a base, with an inner wall;
a lens housing slidably disposed in the base and abutting the inner wall thereof;
a coil disposed in the base, wherein a central axis of the coil in an optical axis direction of the optical device is aligned with a central axis of the lens housing in the optical axis direction; and
a magnetic member connected to the lens housing opposite the coil, providing a first magnetic field, wherein, when the coil is energized to generate a second magnetic field by application of a current in a first current direction, the lens housing slides on the guide bar in a first direction by attraction between the first and second magnetic fields, and when the coil is energized to generate a second magnetic field by application of a current in a second current direction, the lens housing slides on the guide bar in a second direction by repulsion between the first and second magnetic fields.

28. The optical device as claimed in claim 27, further comprising a magnetic-permeable member disposed in the coil to enhance attraction or repulsion between the magnetic member and the coil.

29. The optical device as claimed in claim 27, further comprising a magnetic field sensing member disposed in the base opposite the magnetic member to detect movement of the magnetic member.

30. The optical device as claimed in claim 27, further comprising a positioning member disposed in the base opposite the magnetic member, the positioning member attracting the magnetic member to bring the lens housing into abutment with the inner wall of the base.

31. The optical device as claimed in claim 30, wherein the positioning member comprises metal or a magnet.

32. The optical device as claimed in claim 30, wherein the positioning member comprises a coil capable of being energized to generate a magnetic field to react with the magnetic member.

33. The optical device as claimed in claim 27, further comprising a lens and an image-sensing member, wherein the lens is disposed in the lens housing, and the image-sensing member is disposed in the base opposite the lens.

34. An optical device, comprising:
a base, with an inner wall;
a lens housing slidably disposed in the base and abutting the inner wall thereof;
a coil disposed on the lens housing, wherein a central axis of the coil in an optical axis direction of the optical device is aligned with a central axis -of the lens housing in the optical axis direction; and
a first magnetic member disposed in the base opposite the coil, providing a first magnetic field, wherein, when the coil is energized to generate a second magnetic field by application of a current in a first current direction, the lens housing slides on the guide bar in a first direction by attraction between the first and second magnetic fields, and when the coil is energized to generate a second magnetic field by application of a current in a second current direction, the lens housing slides on the guide bar in a second direction by repulsion between the first and second magnetic fields.

35. The optical device as claimed in claim 34, further comprising a magnetic-permeable member disposed on the lens housing and in the coil to enhance attraction or repulsion between the first magnetic member and the coil.

36. The optical device as claimed in claim 34, further comprising a second magnetic member and a magnetic field sensing member, wherein the second magnetic member is disposed in the lens housing, and the magnetic field sensing member is disposed in the base opposite the second magnetic member to detect movement of the lens housing.

37. The optical device as claimed in claim 34, further comprising a third magnetic member and a positioning member, wherein the third magnetic member is disposed in the lens housing, and the positioning member is disposed in the base opposite the third magnetic member, and the positioning member attracts the third magnetic member to bring the lens housing into abutment with the base.

38. The optical device as claimed in claim 34, further comprising a lens and an image-sensing member, wherein the lens is disposed in the lens housing, and the image-sensing member is disposed in the base opposite the lens.
